(19) United States
(12) Patent Application Publication
(10) Pub. No.: US 2017/0331727 A1
(43) Pub. Date: Nov. 16, 2017

(54) PROTECTION SWITCHING METHOD AND APPARATUS USING OPERATOR'S COMMANDS IN DUAL NODE INTERCONNECTION-BASED PROTECTION SWITCHING

(71) Applicant: ELECTRONICS AND TELECOMMUNICATIONS RESEARCH INSTITUTE, Daejeon (KR)

(72) Inventors: Jeong-dong RYOO, Daejeon (KR); Taesik CHEUNG, Daejeon (KR)

(21) Appl. No.: 15/591,237

(22) Filed: May 10, 2017

(30) Foreign Application Priority Data
May 10, 2016 (KR) 10-2016-0057221
Apr. 14, 2017 (KR) 10-2017-0048358

(51) Int. Cl. H04L 12/703; H04L 12/707

(52) U.S. Cl. CPC H04L 45/28; H04L 45/22

(57) ABSTRACT

A protection switching method and apparatus using operator's command in a dual-node interconnection-based protection switching. An operation method of a third end node receives an operator's command for selecting one of a working path and a protection path in a protection domain, receives information about an isolation status of a second end node and the third end node in an adjacent recovery domain connected through the second end node connected to the working path and the third end node connected to the protection path, determines whether to connect to the second end node based on information about the isolation status, delivers traffic to a path determined based on the operator's command and whether to connect to the second end node, and transfers, to the second end node, information about a connectivity decision including whether to connect to the second end node.

### CROSS-REFERENCE TO RELATED APPLICATION(S)

This application claims the priority benefit of Korean Patent Application No. 10-2016-0057221, filed on May 10, 2016, and Korean Patent Application No. 10-2017-0048358, filed on Apr. 14, 2017, in the Korean Intellectual Property Office, the disclosures of which are incorporated herein by reference for all purposes.

### BACKGROUND

### 1. Field

At least one example embodiment relates to a protection switching method and apparatus using an operator's command in a dual node interconnection-based protection switching, and more particularly, to a protection switching method and apparatus using an operator's command and information about an isolation status in an adjacent recovery domain.

### 2. Description of Related Art

A linear protection switching method according to the related art may protect a physical or logical connection between two end nodes in a single protected domain or protection domain. One end node is connected to the other end node through a working path and a protection path. A protection switching process executed at each end node exchanges information required for protection switching through the protection path so that the two end nodes may exchange user traffic using the same path.

### SUMMARY

At least one example embodiment may provide a method of executing an operator's command in a dual node interconnection-based protection switching.

At least one example embodiment may also provide a method of stably delivering traffic even in an unexpected situation by setting a traffic path based on all of defect situations of an adjacent recovery domain and an operator's command.

According to an aspect of at least one example embodiment, there is provided an operation method of a third end node connected to a first end node through a protection path in a protection domain, the method including receiving an operator's command for selecting one of a working path and the protection path in the protection domain; receiving information about an isolation status of a second end node and the third end node in an adjacent recovery domain connected through the second end node connected to the working path and the third end node connected to the protection path; determining whether to connect to the second end node based on information about the isolation status; delivering traffic through a path determined based on the operator's command and whether to connect to the second end node; and transferring, to the second end node, information about a connectivity decision including whether to connect to the second end node, wherein the third end node is connected to both the first end node through the protection path and the second end node through a vertical path in a protection domain, and wherein the first, second, and third nodes, the protection path, the working path and the vertical path form a triangle.

Information about the isolation status may include information regarding whether each of the second end node and the third end node is normally connected to the adjacent recovery domain without a defect.

The determining may include determining to connect to the second end node when an end node of the working path (i.e., the second node) or the protection path (i.e., the third node) selected in response to the operator's command is isolated in the adjacent recovery domain.

The determining may include determining to connect to the second end node when the working path is selected in response to the operator's command and the second end node is isolated in the adjacent recovery domain.

The determining may include determining to connect to the second end node when the protection path is selected in response to the operator's command and the third end node is isolated in the adjacent recovery domain.

The determining may include determining not to connect to the second node when an end node of the working path (i.e., the second node) or the protection path (i.e., the third node) selected in response to the operator's command is not isolated in the adjacent recovery domain.

The determining may include determining not to connect to the second end node when the working path is selected in response to the operator's command and the second end node is not isolated in the adjacent recovery domain.

The determining may include determining not to connect to the second end node when the protection path is selected in response to the operator's command and the third end node is not isolated in the adjacent recovery domain.

The operator's command may include at least one of a lockout of protection, a forced switch, a manual switch to working path, and a manual switch to protection path with respect to the protection domain.

The operation method may further include transferring the operator's command to the first end node using a protection switch protocol message of the protection domain in response to the operator's command being input from an operator.

According to an aspect of at least one example embodiment, there is provided an operation method of a second end node connected to a first end node through a working path in a protection domain, the method including receiving information about a connectivity decision from a third end node connected to the first end node through a protection path in the protection domain; and connecting two of the first end node, the third end node, and an adjacent recovery domain of the protection domain based on information about the connectivity decision. Information about the connectivity decision is determined based on (a) whether to connect the second end node and the third end node that is determined based on information about an isolation status of the second end node and the third end node in the adjacent recovery domain and (b) an operator's command for selecting one of the working path and a protection path, wherein the third end node is connected to both the first end node through the protection path and the second end node through a vertical path in a protection domain, and wherein the first, second, and third nodes, the protection path, the working path and the vertical path form a triangle.

Information about the isolation status may include information regarding whether each of the second end node and the third end node is normally connected to the adjacent recovery domain without a defect.

Whether to connect the second end node and the third end node may be determined to connect the second end node and the third end node when an end node of the working path (i.e., the second end node) or the protection path (i.e., the third send node) selected in response to the operator's command is isolated in the adjacent recovery domain.

Whether to conned the second end node and the third end node may be determined not to connect the second end node and the third end node when an end node of the working path (i.e., the second end node) or the protection path (i.e., the third send node) selected in response to the operator's command is not isolated in the adjacent recovery domain.

The operator's command may include at least one of a lockout of protection, a forced switch, a manual switch to working path, and a manual switch to protection path with respect to the protection domain.

According to an aspect of at least one example embodiment, there is provided an operation method of a protection domain performing linear protection switching, the method including receiving an operator's command for selecting either a working path that connects a first end node and a second end node in the protection domain or a protection path that connects the first end node and a third end node in the protection domain; receiving information about an isolation status of the second end node and the third end node in an adjacent recovery domain connected to the second end node and the third end node; and determining whether to connect the second end node and the third end node based on information about the isolation status.

Information about the isolation status may include information regarding whether each of the second end node and the third end node is normally connected to the adjacent recovery domain without a defect.

The determining may include determining to connect the second end node and the third end node when an end node of the working path (i.e., the second node) or the protection path (i.e., the third node) selected in response to the operator's command is isolated in the adjacent recovery domain.

The determining may include determining not to connect the second end node and the third end node when an end node of the working path (i.e., the second node) or the protection path (i.e., the third node) selected in response to the operator's command is not isolated in the adjacent recovery domain.

According to an aspect of at least one example embodiment, there is provided a third end node connected to a first end node through a protection path in a protection domain, the third end node including a processor; and a bridge and selector configured to connect two of the first end node, a second end node connected to the first end node through a working path, and an adjacent recovery domain of the protection domain based on a decision of the processor. When at least one instruction is executed by the processor, the processor is configured to receive an operator's command for selecting one of the working path and the protection path in the protection domain, to receive information about an isolation status of a second end node and the third end node in an adjacent recovery domain connected through the second end node connected to the working path and the third end node, to determine whether to connect to the second end node based on information about the isolation status, and to transfer, to the second end node, information about a connectivity decision including whether to connect to the second end node.

According to example embodiments, it is possible to enhance the convenience of an operator's network maintaining and repairing operation in a linear protection switching system and to select a traffic path based on the intent of the operator.

Also, according to example embodiments, it is possible to effectively protect traffic even in an unexpected defect situation during a maintaining and repairing operation by appropriately changing a traffic path based on a defect situation of an adjacent recovery domain while executing an operator's command.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a protection domain according to an example embodiment;

FIGS. 2 and 3 illustrate examples of describing an operator command used for a linear protection switching according to an example embodiment;

FIG. 4 illustrates an example of a protection domain and an adjacent recovery domain according to an example embodiment;

FIG. 5 illustrates an example of a protection domain and an adjacent recovery domain connected through two end nodes according to an example embodiment;

FIG. 6 illustrates an example of a path for delivering traffic in a protection domain according to an example embodiment;

FIGS. 7 through 9 are flowcharts illustrating examples of an operation method according to an example embodiment; and

FIG. 10 is a block diagram illustrating an example of an end node according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The following example embodiments may be used to perform linear protection switching in a protection domain. Herein, an operation of performing linear protection switching in a protection domain may include an operation of performing linear protection switching in response to an operator's commands. The example embodiments may be configured through a computing device for delivering traffic. Herein after, the example embodiments will be described with reference to the accompanying drawings. Like reference numerals refer to like elements throughout.

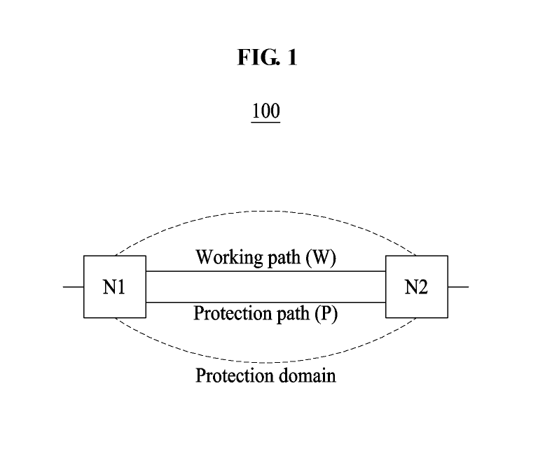

FIG. 1 illustrates an example of a protection domain according to an example embodiment.

Referring to FIG. 1, a protection domain 100 may include a first end node N1 and a second end node N2.

The first end node N1 and the second end node N2 included in the protection domain 100 may be connected to each other through a working path W and a protection path P and may transmit and receive traffic.

A path used herein may indicate a passage through which traffic is delivered between two end nodes, and at least one intermediate node may be present in the path between the two end nodes. The intermediate node performs only the functionality of delivering traffic and does not perform a protection switching operation. Thus, for clarity of description, the intermediate node may not be illustrated. A single path may be present in a single physical link or port. Alternatively, a plurality of paths may be logically present in a single physical link or port. Alternatively, a plurality of physical links or ports may be configured using a single logical path.

A protection switching process executed at each end node may exchange information required for protection switching through the protection path, so that two end nodes may exchange traffic using the same path. For example, in a normal state, two end nodes may exchange traffic using the working path. If a defect of the working path is detected by any one end node, the two end nodes may exchange traffic using the protection path by exchanging information of the protection switching process. A linear protection switching method may include International Telecommunications Union-Telecommunication (ITU-T) Recommendation G.8031 (Ethernet linear protection switching), G.8131 (Multi-Protocol Label Switching-Transport Profile (MPLS-TP) linear protection switching), G.873.1 (Optical Transport Network (OTN) linear protection switching), Internet Engineering Task Force (IETF) RFC 6378 (MPLS-TP linear protection switching—Protection State Coordination (PSC) mode, RFC 7271 (MPLS-TP linear protection switching—Automatic Protection Switching (APS) mode, and the like.

The linear protection switching may select a specific path in response to an operator's command as well as the defect occurring in the path. The operator's command may include at least one of a lockout of protection (LO), a forced switch (FS), a manual switch to working path (MS-W), and a manual switch to protection path (MS-P). The operator's command may be classified based on a selected path. For example, the lockout of protection (LO) and the manual path to working path (MS-W) may be the operator's commands to use the working path for traffic delivery. The forced switch (FS) and the manual path to protection path (MS-P) may be the operator's commands to use the protection path for the traffic delivery.

That is, a plurality of operator's commands may be present to use the same path, which is directed to change priority based on whether a defect is present in the path. For example, in the case of the manual path to working path (MS-W) and the manual path to protection path (MS-P), if the defect occurs in the corresponding path, the operator's corresponding command may not be applied. However, in the case of the lockout of protection and the forced switch (FS), the operator's corresponding command may be applied regardless of the occurrence of the defect in the path. That is, a plurality of operator's commands using the same path may be present and priority between the operator's command and a presence/absence of the defect in the path may be set to be different. In this manner, linear protection switching may be effectively performed through the operator's command suitable for a situation.

The priority between the operator's command and the presence/absence of the defect in the path may be defined to be different based on target technology, for example, Ethernet, MPLS-TP, OTN, and the like, of the linear protection switching.

Herein, for clarity of description, example embodiments are described based on the lockout of protection (LO) for selecting the working path and the forced switch (FS) for selecting the protection path.

In general, the operator's command according to an example embodiment may be transferred to a single end node. The end node that receiving the operator's command may transfer the received operator's command to another end node as a protection switching protocol message using the protection path. In this manner, traffic may be delivered through a path designated in the operator's command.

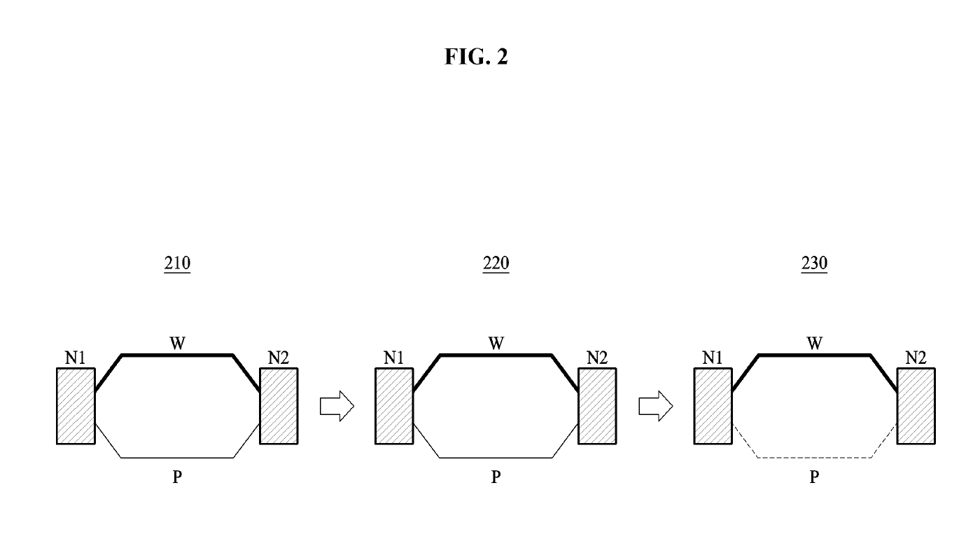

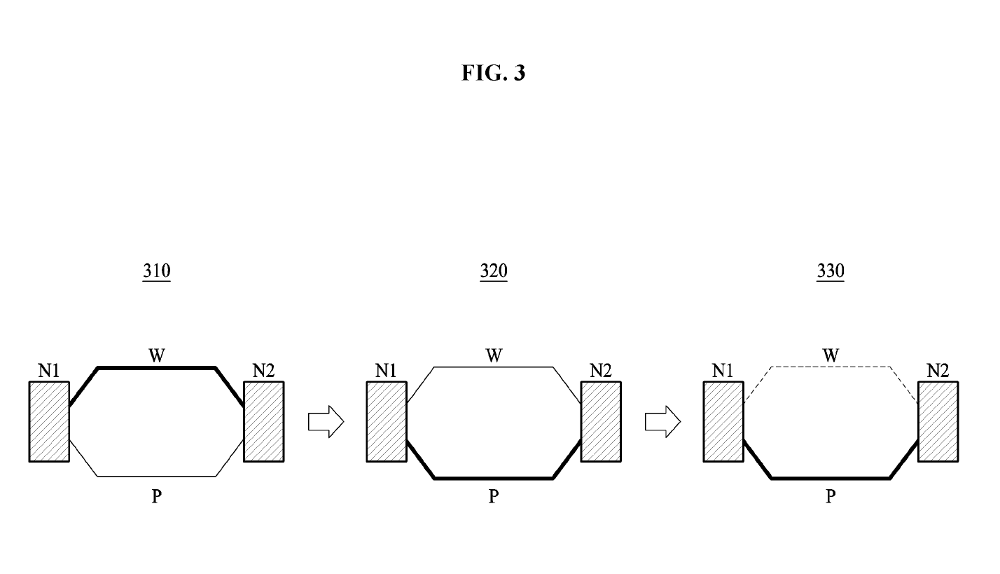

FIGS. 2 and 3 illustrate examples of describing an operator command used for a linear protection switching according to an example embodiment.

A process of performing protection switching in response to a lockout of protection (LO) according to an example embodiment is described with reference to FIG. 2.

Referring to FIG. 2, in operation 210, a protection domain may be in a normal state in which a defect is absent and traffic is delivered through a working path W. That is, a first end node N1 and a second end node N2 may transmit and receive traffic through the working path W.

In operation 220, if the lockout of protection (LO) is received in the normal state, the first end node N1 and the second end node N2 may maintain the working path W.

In operation 230, in a situation in which the lockout of protection (LO) is maintained, an operator may perform a maintaining and repairing operation for the protection path P. That is, the operator may maintain and repair a cable and equipment of the protection path P. Regardless of an occurrence of a defect in the path during the maintaining and repairing operation corresponding to the lockout of protection (LO), the traffic may be delivered through the working path W.

A process of performing protection switching in response to a forced switch (FS) according to an example embodiment is described with reference to FIG. 3.

Referring to FIG. 3, in operation 310, a protection domain may be in a normal state in which a defect is absent and traffic is delivered through a working path W. That is, a first end node N1 and a second end node N2 may transmit and receive traffic through the working path W.

In operation 320, if the forced switch (FS) is received in the normal state, the first end node N1 and the second end node N2 may change the working path W with a protection path P and may transmit and receive the traffic through the protection path P.

In operation 330, in a situation in which the forced switch (FS) is maintained, an operator may perform a maintaining and repairing operation for the working path W. That is, the operator may maintain and repair a cable and equipment of the working path W. Regardless of an occurrence of the defect in the path during the maintaining and repairing operation by the forced switch (FS), the traffic may be delivered through the working path W.

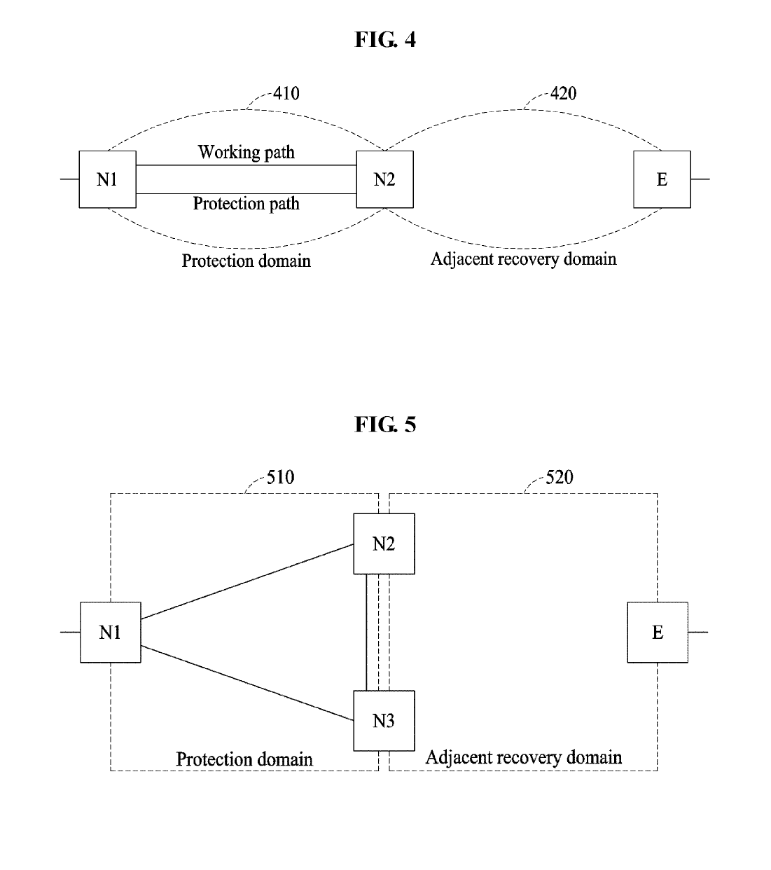

FIG. 4 illustrates an example of a protection domain and an adjacent recovery domain according to an example embodiment.

Referring to FIG. 4, a protection domain 410 and an adjacent recovery domain 420 are connected using a single node.

Without being limited to specific one, various traffic protection technologies may be employed for the adjacent recovery domain 420.

The protection domain 410 and the adjacent recovery domain 420 connected using a single node interconnection method may be connected through a second end node N2. In this case, if a defect occurs in the second end node N2, the traffic delivery may not be performed between a first end node N1 of the protection domain 410 and an end node E of the adjacent recovery domain 420.

FIG. 5 illustrates an example of a protection domain and an adjacent recovery domain connected through two end nodes according to an example embodiment.

Referring to FIG. 5, a protection domain 510 and an adjacent recovery domain 520 are connected using a dual node scheme.

The protection domain 510 and the adjacent recovery domain 520 may be connected through two end nodes, for example, a second end node N2 and a third end node N3. Here, the protection domain 510 may represent a domain that is protected by a linear protection switching scheme and the adjacent recovery domain 520 may represent a domain that is protected by predetermined protection technology. For clarity of description, a connection path within the adjacent recovery domain 520 is not particularly illustrated in FIG. 5.

The above dual node interconnection method may use two end nodes as connection nodes and may protect the traffic being delivered between a first end node N1 and an end node E although a defect occurs in a single end node.

For example, when a defect occurs in a path between the second end node N2 and the adjacent recovery domain 520 while delivering traffic through a working path that connects the first end node N1 and the second end node N2 in the protection domain 510, the traffic may be exchanged with the adjacent recovery domain 520 through the third end node N3 by connecting the second end node N2 and the third end node N3. That is, the traffic may be exchanged through N1-N2-N3 path.

As another example, when a defect occurs in a path between the third end node N3 and the adjacent recovery domain 520 while delivering traffic through a protection path that connects the first end node N1 and the third end node N3 in the protection domain 510, the traffic may be normally exchanged with the adjacent recovery domain 520 through the second end node N2 by connecting the second end node N2 and the third end node N3. That is, the traffic may be exchanged through N1-N3-N2 path.

Here, one of the working path and the protection path in the protection domain 510 may be selected in response to an operator's command, and may be used to deliver the traffic. For example, the working path may be selected when the operator's command is a lockout of protection (LO) or a manual path to working path (MS-W), and the protection path may be selected when the operator's command is a forced switch (FS) or a manual path to protection path (MS-P). The operator's command may be received by the first end node N1 or the third end node N3. Once the operator's command is received by any one end node, the received operator's command may be transferred to the other end node through the protection path.

Also, whether to connect a vertical path between the second end node N2 and the third end node N3 may be determined based on an isolation status of the second end node N2 and the third end node N3 in the adjacent recovery domain 520. Here, information about the isolation status may include information whether each of the second end node N2 and the third end node N3 is normally connected to the adjacent recovery domain 520 without a defect.

In detail, when an end node of the working path (i.e., the second node) or the protection path (i.e., the third node) selected in response to the operator's command is isolated in the adjacent recovery domain 520, the vertical path may be determined to be connected between the second end node N2 and the third end node N3. For example, when the working path is selected in the protection domain 510 in response to the operator's command and, in this instance, the second end node N2 is isolated in the adjacent recovery domain 520, the traffic may be delivered through N1-N2-N3 path. Also, when the protection path is selected in the protection domain 510 in response to the operator's command and, in this instance, the third end node N3 is isolated in the adjacent recovery domain 520, the vertical path may be connected between the second end node N2 and the third end node N3 and the traffic may be delivered through N1-N3-N2 path.

On the contrary, when the end node of the working path or the protection path selected in response to the operator's command is not isolated in the adjacent recovery domain 520, the vertical path may be determined not to be connected between the second end node N2 and the third end node N3. For example, when the working path is selected in the protection domain 510 in response to the operator's command and, in this instance, the second end node N2 is not isolated in the adjacent recovery domain 520, the traffic may be immediately delivered to the adjacent recovery domain 520 through the second end node N2. Thus, there is no need to connect the vertical path between the second end node N2 and the third end node N3. Also, when the protection path is selected in the protection domain 510 in response to the operator's command and, in this instance, the third end node N3 is not isolated in the adjacent recovery domain 520, the traffic may be immediately delivered to the adjacent recovery domain 520 through the third end node N3. Thus, there is no need to connect the vertical path between the second end node N2 and the third end node N3.

Although the aforementioned operator's command is defined based on the selected path, the operator's commands may be variously defined in detail based on priority of various types of defects.

For example, the operator's command may be defined for each of N1-N2 path, N1-N2-N3 path, N1-N3 path, and N1-N3-N2 path for the traffic delivery between the first end node N1 and the end node E. When the operator's command is received by a single end node in the protection domain 510, the corresponding end node may transfer the received operator's command to the other end node so that the traffic may be delivered through the corresponding path.

According to an example embodiment, a master process, EDNI master in case of Ethernet Dual Node Interconnection (EDNI), included in the third end node N3 and a slave process, EDNI slave in case of Ethernet Dual Node Interconnection, included in the second end node N2 may determine whether the vertical path is to be used for the traffic delivery based on the isolation status of the second end node N2 and the third end node N3. Here, the vertical path may indicate a path that connects the second end node N2 and the third end node N3. Also, the operator's command may be issued at the first end node N1 or the third end node N3.

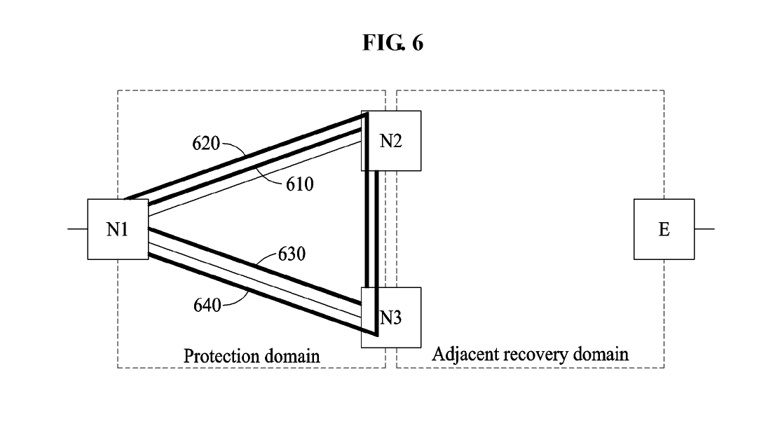

FIG. 6 illustrates an example of a path for delivering traffic in a protection domain according to an example embodiment.

FIG. 6 illustrates paths settable in the protection domain according to an example embodiment.

When a working path is selected in response to an operator's command and a second end node N2 of the working path is not isolated in an adjacent recovery domain, N1-N2 path 610 may be set. When the working path is selected in response to the operator's command and the second end node N2 of the working path is isolated in the adjacent recovery domain, N1-N2-N3 path 620 to which a vertical path is additionally connected may be set.

When a protection path is selected in response to the operator's command and a third end node N3 of the protection path is not isolated in the adjacent recovery domain, N1-N3 path 630 may be set. When the protection path is selected in response to the operator's command and the third end node N3 of the protection path is isolated in the adjacent recovery domain, N1-N3-N2 path 640 to which the vertical path is additionally connected may be set.

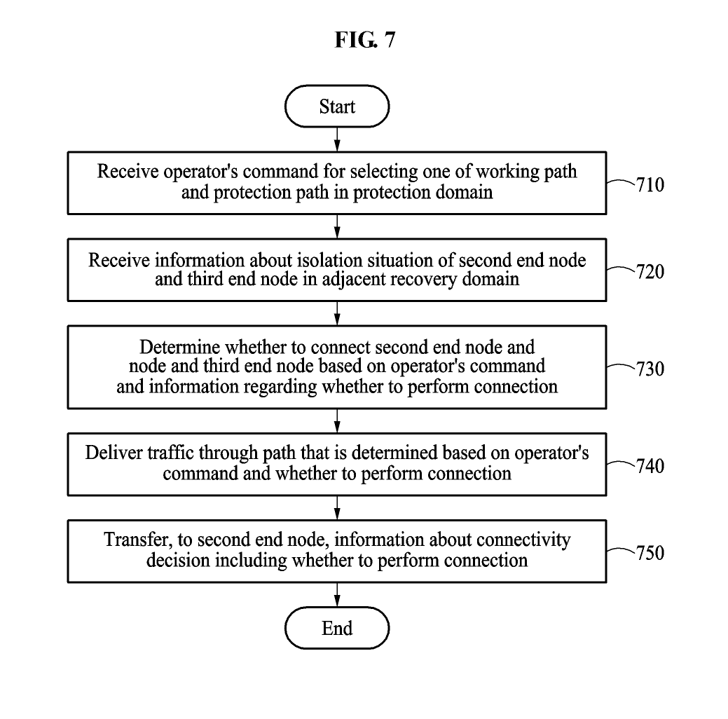

FIGS. 7 through 9 are flowcharts illustrating examples of an operation method according to an example embodiment.

An operation method of a third end node of a protection path according to an example embodiment is described with reference to FIG. 7.

Referring to FIG. 7, in operation 710, the third end node receives an operator's command for selecting one of a working path and the protection path in a protection domain. Here, the operator's command may include at least one of a lockout of protection (LO), a forced switch (FS), a manual path to working path (MS-W), and a manual path to protection path (MS-P) with respect to the protection domain.

The third end node may directly receive the operator's command from an operator, or may receive the operator's command from a first end node that directly receives the operator's command from the operator, through a protection switching protocol message of the protection domain. When the operator's command is input from the operator, the third end node may transfer the operator's command to the first end node as the protection switching protocol message of the protection domain.

In operation 720, the third end node receives information about an isolation status of a second end node and third end node in an adjacent recovery domain that is connected through the second end node connected to the working path and the third end node.

Here, information about the isolation status may include information regarding whether each of the second end node and the third end node is normally connected to the adjacent recovery domain without a defect.

In operation 730, the third end node determines whether to connect to the second end node based on information about the isolation status.

When an end node of the working path (i.e., the second node) or the protection path (i.e., the third node) selected in response to the operator's command is isolated in the adjacent recovery domain, the third end node may determine to connect to the second end node. When the working path is selected in response to the operator's command and, in this instance, the second end node is isolated in the adjacent recovery domain, the third end node may determine to connect to the second end node. When the protection path is selected in response to the operator's command and, in this instance, the third end node is isolated in the adjacent recovery domain, the third end node may determine to connect to the second end node.

Also, when an end node of the working path (i.e., the second node) or the protection path (i.e., the third node) selected in response to the operator's command is not isolated in the adjacent recovery domain, the third end node may determine not to connect to the second end node. When the working path is selected in response to the operator's command and, in this instance, the second end node is not isolated in the adjacent recovery domain, the third end node may determine not to connect to the second end node. When the protection path is selected in response to the operator's command and, in this instance, the third end node is not isolated in the adjacent recovery domain, the third end node may determine not to connect to the second end node.

In operation 740, the third end node delivers traffic through the path that is determined based on the operator's command and whether to connect to the second end node.

In operation 750, the third end node transfers, to the second end node, information about a connectivity decision including whether to connect to the second end node determined in operation 730. That is, information about the connectivity decision transferred from the third end node to the second end node may include information regarding whether to use a vertical path that connects the second end node and the third end node.

The description made above with reference to FIGS. 1 through 6 may be applied to operations of FIG. 7 and a further description is omitted here.

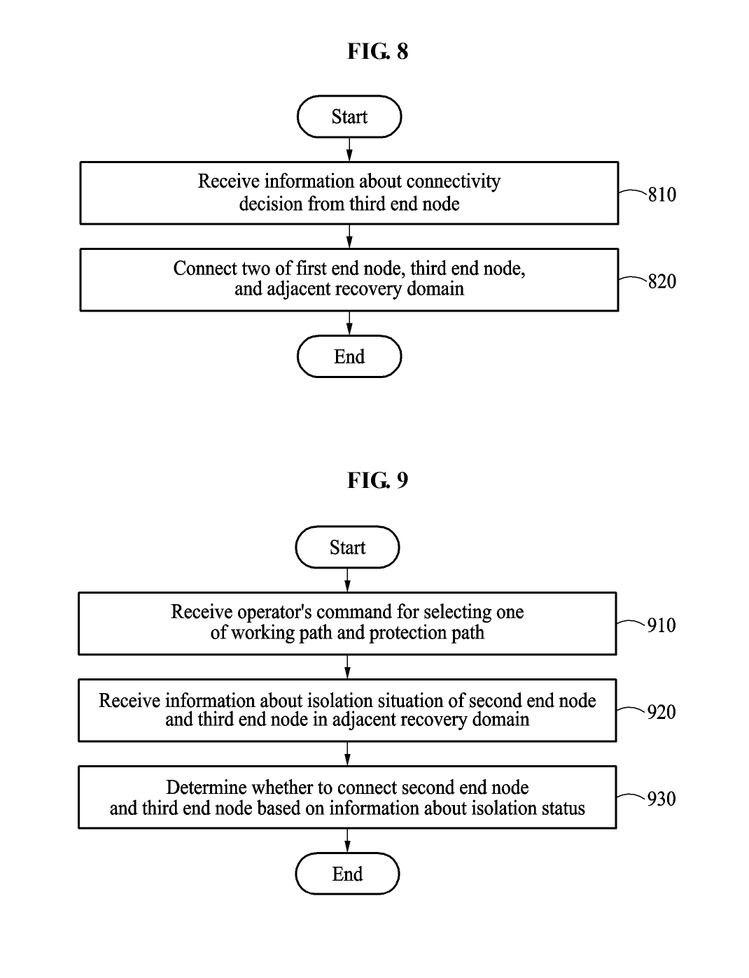

Hereinafter, an operation method of a second end node of a working path according to an example embodiment is described with reference to FIG. 8.

In operation 810, the second end node receives information about a connectivity decision from a third end node in a protection domain.

Information about the connectivity decision may be determined based on (a) whether to connect the second end node and the third end node that is determined based on information about an isolation status of the second end node and the third end node in an adjacent recovery domain and (b) an operator's command for selecting one of the working path and a protection path.

Information about the isolation status may include information regarding whether each of the second end node and the third end node is normally connected to the adjacent recovery domain without a defect.

Whether to connect the second end node and the third end node may be determined to connect the second end node and the third end node when an end node of the working path (i.e., the second node) or the protection path (i.e., the third node) selected in response to the operator's command is isolated in the adjacent recovery domain. Also, whether to connect the second end node and the third end node may be determined not to connect the second end node and the third end node when the end node of the working path or the protection path selected in response to the operator's command is not isolated in the adjacent recovery domain.

In operation 820, the second end node connects two of the first end node, the third end node, and the adjacent recovery domain based on information about the connectivity decision.

The description made above with reference to FIGS. 1 through 7 may be applied to operations of FIG. 8 and a further description is omitted here.

Hereinafter, an operation method of a protection domain including a second end node and a third end node according to an example embodiment is described with reference to FIG. 9.

In operation 910, the protection domain receives an operator's command for selecting either working path that connects a first end node and the second end node in the protection domain or a protection path that connects the first end node and the third end node in the protection domain. For example, the operator's command may be input to one of the first end node and the third end node in the protection domain. The operator's command input to any one end node may be transferred to the other end node through a protection switching protocol message of the protection domain.

In operation 920, the protection domain receives information about an isolation status of the second end node and the third end node in an adjacent recovery domain connected to the second end node and the third end node. Information about the isolation status may include information regarding whether each of the second end node and the third end node is normally connected to the adjacent recovery domain without a defect.

In operation 930, the protection domain determines whether to connect the second end node and the third end node based on information about the isolation status.

When an end node of the working path (i.e., the second node) or the protection path (i.e., the third node) selected in response to the operator's command is isolated in the adjacent recovery domain, the protection domain may determine to connect the second end node and the third end node. Also, when the end node of the working path or the protection path selected in response to the operator's command is not isolated in the adjacent recovery domain, the protection domain may determine not to connect the second end node and the third end node.

The description made above with reference to FIGS. 1 through 8 may be applied to operations of FIG. 9 and a further description is omitted here.

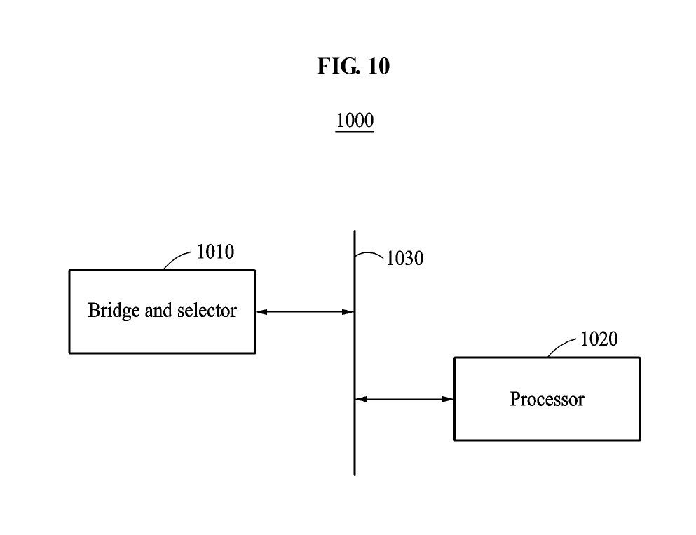

FIG. 10 is a block diagram illustrating an example of an end node according to an example embodiment.

Referring to FIG. 10, an end node 1000 includes a bridge and selector 1010 and a processor 1020. The bridge and selector 1010 and the processor 1020 may communicate with each other through a bus 1030.

When the end node 1000 is a third end node of a protection path, the bridge and selector 1010 connects two of a first end node, a second end node connected to the first end node through a working path, and an adjacent recovery domain of a protection domain, based on a decision of the processor 1030. Alternatively, when the end node 1000 is a second end node of the working path, the bridge and selector 1010 connects two of the first end node, the third end node connected to the first end node through the protection path, and the adjacent recovery domain of the protection domain, based on a decision of the processor 1030.

The processor 1020 may be an apparatus configured to execute instructions or programs or to control the end node 1000.

When the end node 1000 is the third end node of the protection path, the processor 1020 receives an operator's command for selecting one of the working path and the protection path in the protection domain. The processor 1020 receives information about an isolation status of the second end node and the third end node from the adjacent recovery domain connected to the second end node connected to the working path and the third end node. The processor 1020 determines whether to connect to the second end node based on information about the isolation status. The processor 1020 delivers traffic through a path that is determined based on the operator's command and whether to connect to the second end node, and transfers, to the second end node, information about a connectivity decision including information regarding whether to connect to the second end node.

When the end node 1000 is the second end node of the working path, the processor 1020 receives information about the connectivity decision from the third end node connected to the first end node through the protection path in the protection domain. The processor 1020 connects two of the first end node, the third end node, and the adjacent recovery domain based on information about the connectivity decision. Here, information about the connectivity decision may be determined based on (a) whether to connect the second end node and the third end node that is determined based on information about the isolation status of the second end node and the third end node in the adjacent recovery domain and (b) the operator's command for selecting one of the working path and the protection path.

The description made with reference to FIGS. 1 through 9 may be applied to operations of FIG. 10 and a further description is omitted.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include plurality of processing elements and plurality of types of processing elements. For example, a processing device may include plurality of processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method of a third end node connected to a first end node through a protection path in a protection domain, the operation method comprising:
receiving an operator's command for selecting one of a working path and the protection path in the protection domain;
receiving information about an isolation status of a second end node and the third end node in an adjacent recovery domain connected through the second end node connected to the working path and the third end node connected to the protection path;
determining whether to connect to the second end node based on information about the isolation status;
delivering traffic through a path determined based on the operator's command and whether to connect to the second end node; and
transferring, to the second end node, information about a connectivity decision including whether to connect to the second end node,
wherein the third end node is connected to both the first end node through the protection path and the second end node through a vertical path in a protection domain, and
wherein the first, second, and third nodes, the protection path, the working path and the vertical path form a triangle.

2. The operation method of claim 1, wherein information about the isolation status includes information regarding whether each of the second end node and the third end node is normally connected to the adjacent recovery domain without a defect.

3. The operation method of claim 1, wherein the determining comprises determining to connect to the second end node when an end node of the working path or the protection path selected in response to the operator's command is isolated in the adjacent recovery domain.

4. The operation method of claim 2, wherein the determining comprises determining to connect to the second end node when the working path is selected in response to the operator's command and the second end node is isolated in the adjacent recovery domain.

5. The operation method of claim 2, wherein the determining comprises determining to connect to the second end node when the protection path is selected in response to the operator's command and the third end node is isolated in the adjacent recovery domain.

6. The operation method of claim 1, wherein the determining comprises determining not to connect to the second node when an end node of the working path or the protection path selected in response to the operator's command is not isolated in the adjacent recovery domain.

7. The operation method of claim 6, wherein the determining comprises determining not to connect to the second end node when the working path is selected in response to the operator's command and the second end node is not isolated in the adjacent recovery domain.

8. The operation method of claim 6, wherein the determining comprises determining not to connect to the second end node when the protection path is selected in response to the operator's command and the third end node is not isolated in the adjacent recovery domain.

9. The operation method of claim 1, wherein the operator's command includes at least one of a lockout of protection, a forced switch, a manual switch to working path, and a manual switch to protection path with respect to the protection domain.

10. The operation method of claim 1, further comprising:
transferring the operator's command to the first end node using a protection switch protection message of the protection domain in response to the operator's command being input from an operator.

11. An operation method of a second end node connected to a first end node through a working path in a protection domain, the operation method comprising:
receiving information about a connectivity decision from a third end node connected to the first end node through a protection path in the protection domain; and
connecting two of the first end node, the third end node, and an adjacent recovery domain of the protection domain based on information about the connectivity decision,
wherein information about the connectivity decision is determined based on (a) whether to connect the second end node and the third end node that is determined based on information about an isolation status of the second end node and the third end node in the adjacent recovery domain and (b) an operator's command for selecting one of the working path and a protection path,
wherein the third end node is connected to both the first end node through the protection path and the second end node through a vertical path in a protection domain, and
wherein the first, second, and third nodes, the protection path, the working path and the vertical path form a triangle.

12. The operation method of claim 11, wherein information about the isolation status includes information regarding whether each of the second end node and the third end node is normally connected to the adjacent recovery domain without a defect.

13. The operation method of claim 11, wherein whether to connect the second end node and the third end node is determined to connect the second end node and the third end node when an end node of the working path or the protection path selected in response to the operator's command is isolated in the adjacent recovery domain.

14. The operation method of claim 11, wherein whether to conned the second end node and the third end node is determined not to connect the second end node and the third end node when an end node of the working path or the protection path selected in response to the operator's command is not isolated in the adjacent recovery domain.

15. The operation method of claim 11, wherein the operator's command includes at least one of a lockout of protection, a forced switch, a manual switch to working path, and a manual switch to protection path with respect to the protection domain.

16. An operation method of a protection domain performing linear protection switching, the method comprising:
receiving an operator's command for selecting either a working path that connects a first end node and a second end node in the protection domain or a protection path that connects the first end node and a third end node in the protection domain;
receiving information about an isolation status of the second end node and the third end node in an adjacent recovery domain connected to the second end node and the third end node; and
determining whether to connect the second end node and the third end node based on information about the isolation status.

17. The operation method of claim 16, wherein information about the isolation status includes information regarding whether each of the second end node and the third end node is normally connected to the adjacent recovery domain without a defect.

18. The operation method of claim 16, wherein the determining comprises determining to connect the second end node and the third end node when an end node of the working path or the protection path selected in response to the operator's command is isolated in the adjacent recovery domain.

19. The operation method of claim 16, wherein the determining comprises determining not to connect the second end node and the third end node when an end node of the working path or the protection path selected in response to the operator's command is not isolated in the adjacent recovery domain.
